(19) United States
(12) Patent Application Publication
(10) Pub. No.: US 2018/0194602 A1
(43) Pub. Date: Jul. 12, 2018

(54) RAM RETRACT SYSTEM FOR A LIFT

(71) Applicant: Gray Manufacturing Company, Inc., St. Joseph, MO (US)

(72) Inventors: Seth A. Helmich, Savannah, MO (US); William R. Keck, Rea, MO (US)

(21) Appl. No.: 15/869,772

(22) Filed: Jan. 12, 2018

Related U.S. Application Data
(60) Provisional application No. 62/445,431, filed on Jan. 12, 2017.

(51) Int. Cl. B66F 7/06; B66F 7/24; B66F 7/08; B66F 7/28

(52) U.S. Cl. CPC B66F 7/0608; B66F 7/24; B66F 7/28; B66F 7/08; B66F 7/0625

(57) ABSTRACT

A lift for raising and lowering items, such as vehicles. The lift comprises a lifting assembly including a cylinder and a ram configured to extend from and retract within the cylinder. The lift additionally includes an air-storage reservoir configured to store pressurized air received from an external air source. The air-storage reservoir is fluidly connected to the lifting assembly, such that the air-storage reservoir is configured to cause the ram to retract within the cylinder even when the lift is not connected to the external air source.

### CROSS-REFERENCE TO RELATED APPLICATIONS

This non-provisional patent application claims priority to earlier-filed U.S. Provisional Patent Application No. 62/445,431 filed Jan. 12, 2017, and entitled “RAM RETRACT SYSTEM FOR A LIFT.” The entirety of the above-identified provisional patent application is hereby incorporated by reference into this non-provisional patent application.

### FIELD OF THE DISCLOSURE

The field of the disclosure relates generally to systems and methods for lifting and lowering heaving items. More particularly, the present disclosure relates to systems and methods for fully retracting rams used in hydraulic lifts.

### BACKGROUND OF THE DISCLOSURE

Hydraulically-operated lifts, such as bottle jacks and/or floor-service lifts, have been used in the vehicle service industry for many decades. Such lifts generally include a hydraulic cylinder with a ram configured to extend from and retract within the cylinder. In operation, the ram extends and retracts by adjusting the hydraulic pressure forced into a ram chamber (formed within the hydraulic cylinder) from a hydraulic-fluid reservoir. Depending on the type of lift, the hydraulic pressure applied against the ram may be adjusted pneumatically (e.g., air pump) and/or mechanically (e.g., hand-operated lever pump). In more detail, many previously-used hydraulic lifts were designed to operate mechanically by manually actuating a handle of the lift. More recent designs incorporated an air motor that used compressed air (from an external air-pressure source) to provide power to the lift.

After such a previously-used lift had been used (e.g., for raising and/or lowering a vehicle), the ram of the lift would retract back within the cylinder due to the inherent weight of the ram and/or the weight of the item being lifted. However, many rams are not heavy enough to fully retract within the cylinder because their weight cannot fully overcome the force of hydraulic fluid within the ram chamber. It can be problematic if the ram is not permitted to fully retract within the cylinder because if it does not, the ram can (1) be damaged if impacted by another object, (2) cause damage to other objects, and/or (3) reduce maneuverability of the jack, such as by becoming entangled in the item (e.g., the vehicle) that was being lifted. For example, situations have occurred where a lift is used to raise and then lower a vehicle, and then the vehicle is driven off the lift without the ram being fully retracted. In such situations, the vehicle and/or the lift can be damaged or rendered unusable

To alleviate such issues associated with the ram not fully retracting within the cylinder, some previously-used lifts included mechanical springs attached to the ram and to another portion of the lift. Such springs could function to pull the ram down within the cylinder to its minimum starting height. Unfortunately, such springs are generally exposed to the environment and eventually deteriorate or become damaged, such that the springs cease to function properly.

### BRIEF DESCRIPTION OF THE DISCLOSURE

This summary is not intended to identify essential features of the present invention, and is not intended to be used to limit the scope of the claims. These and other aspects of the present invention are described below in greater detail.

In one aspect, embodiments include a lift for raising and lowering items. The lift comprises a lifting assembly including a cylinder and a ram configured to extend from and retract within the cylinder. The lift additionally includes an air-storage reservoir configured to store pressurized air received from an external air source. The air-storage reservoir is fluidly connected to the lifting assembly, such that the air-storage reservoir is configured to cause the ram to retract within the cylinder even when the lift is not connected to the external air source.

In another aspect, embodiments include a lift for raising and lowering vehicles. The lift comprises a lifting assembly including a cylinder, and a ram configured to extend from and retract within the cylinder. A space is presented between the cylinder and the ram. The lift further includes an air-storage reservoir fluidly connected to the space between the cylinder and the ram and configured to generate a pneumatic force against the ram so as to retract the ram within said cylinder. The air-storage reservoir is configured to generate the pneumatic force without being connected to an external air source.

In yet another aspect, embodiments include a method of operating a lift, with the lift including a cylinder, a ram, and an air-storage reservoir. The method comprises a step of connecting the lift to an external air source. An additional step includes raising the vehicle with the lift. An additional step includes disconnecting the external air source from the lift. An additional step includes lowering the vehicle with the lift. A further step includes, after the disconnecting and lowering steps, causing, via compressed air stored within the air-storage reservoir, the ram to retract within the cylinder.

### BRIEF DESCRIPTION OF THE DRAWINGS

Embodiments of the present invention are described in detail below with reference to the attached drawing figures, wherein:

FIG. 1 is a left side perspective view of a lift according to embodiments of the present invention being used to lift an item;

FIG. 2 is a right side perspective view of the lift from FIG. 1;

FIG. 3 is a left elevational view of the lift from FIGS. 1 and 2, with a portion of a handle of the lift cut away, and particularly illustrating a lifting assembly of the lift with a ram extending from a cylinder to support the item;

FIG. 4 is another left elevational view of the lift from FIG. 3, with the ram retracted within the cylinder, such that the item is not being supported;

FIG. 5 is perspective view of the lift from FIGS. 1-4 with a portion of the handle and a housing of the lift cut away to illustrate an air-storage reservoir in fluid communication with the lifting assembly;

FIG. 6 is a perspective view of the air-storage reservoir and the lifting assembly from FIGS. 4 and 5;

FIG. 7 is a top plan view of the air-storage reservoir and the lifting assembly from FIG. 6;

FIG. 8 is a cross-section taken along the line 8-8 from FIG. 7, particularly illustrating a ram being extended from a cylinder of the lifting assembly; and

FIG. 9 is another cross-section, similar to the cross-section of FIG. 8, taken along the line 8-8 from FIG. 7, particularly illustrating the ram being retracted within the cylinder of the lifting assembly.

The figures are not intended to limit the present invention to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, operation, etc. described in one embodiment may also be included in other embodiments, but is not necessarily included. Thus, particular implementations of the present invention can include a variety of combinations and/or integrations of the embodiments described herein.

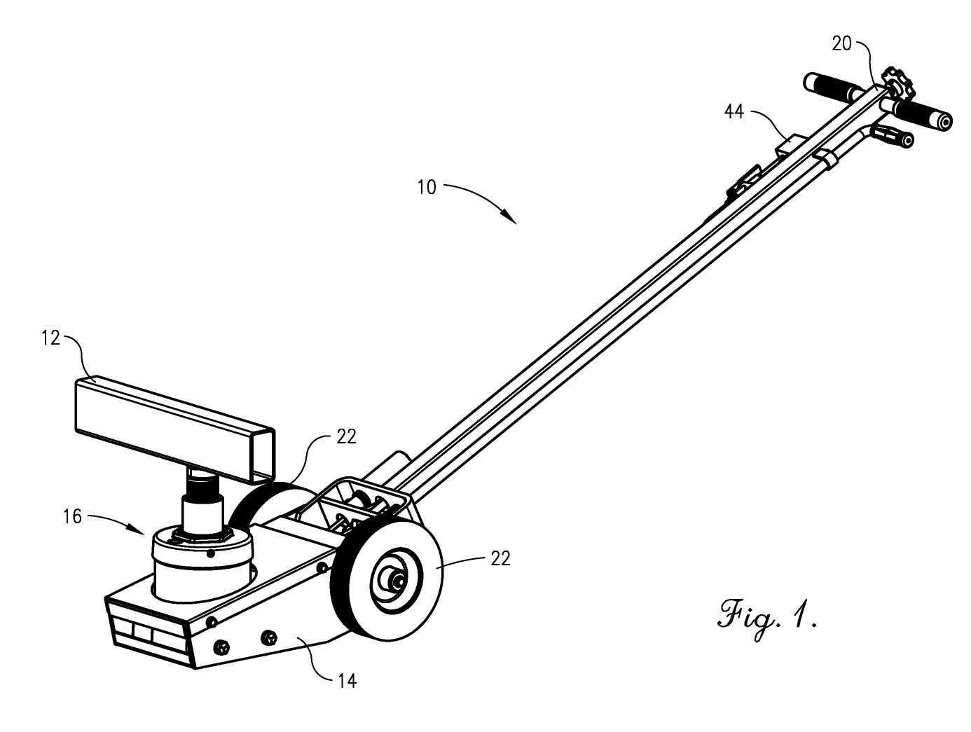

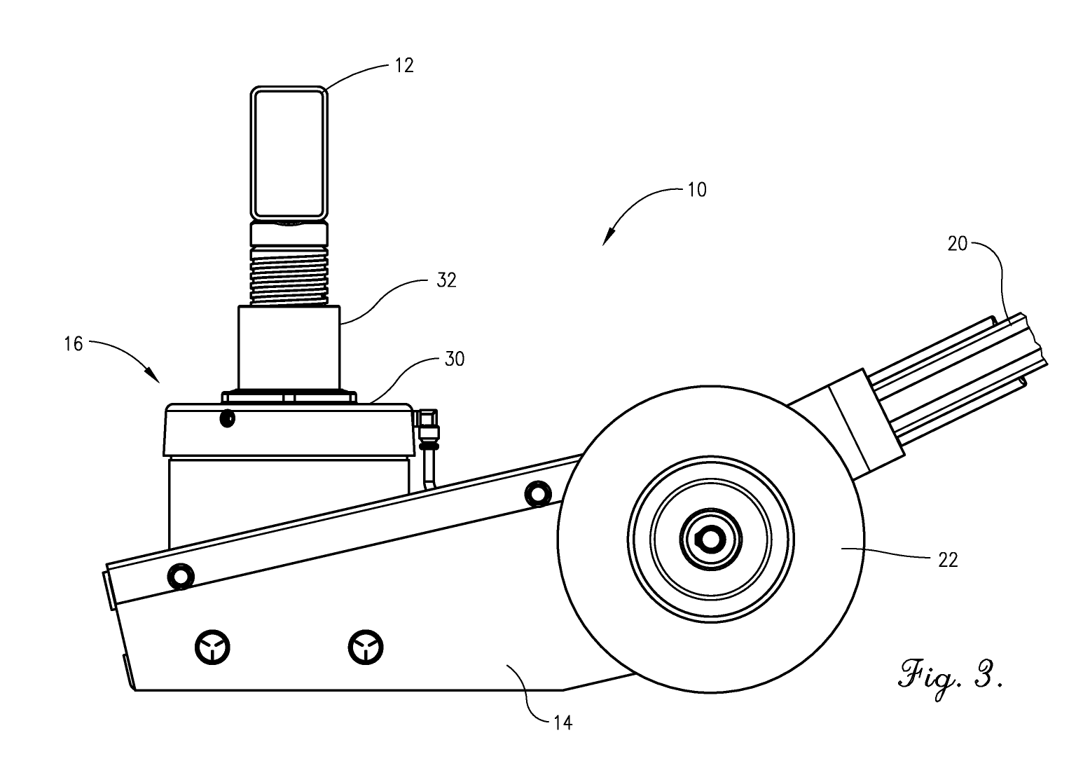

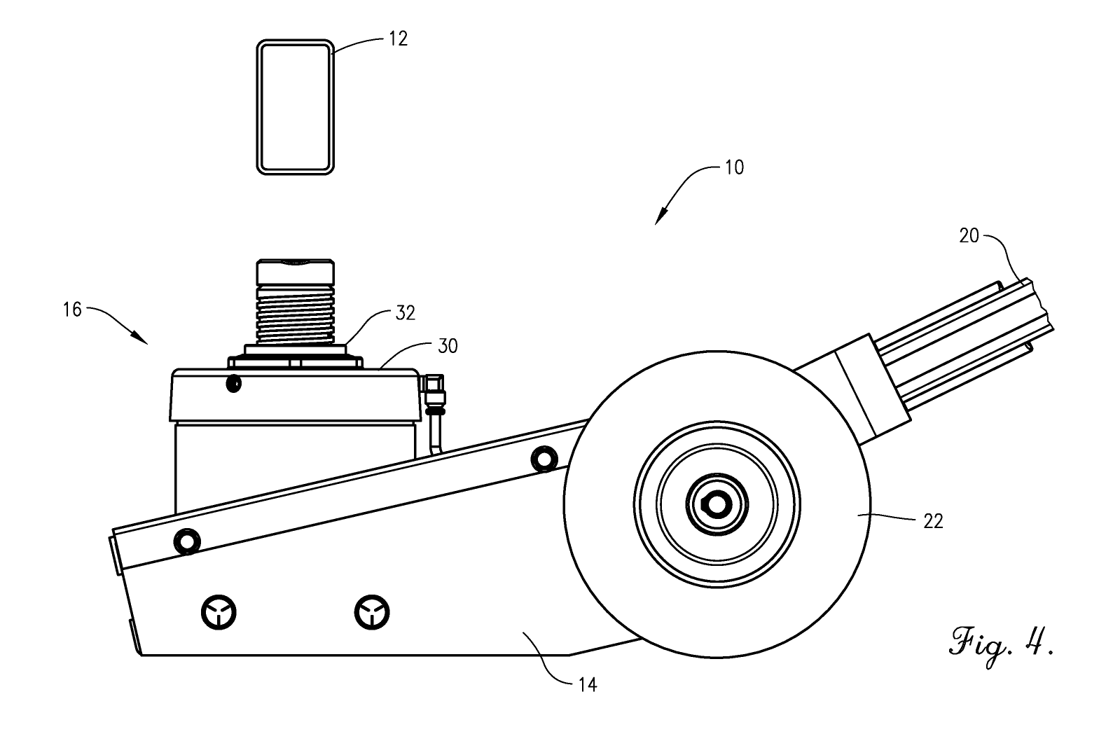

Broadly characterized, the present invention relates to systems and methods for retracting lifts after the lifts have been used raise and/or lower and item. In more detail, embodiments of the present invention are directed to a lift with a ram retract system. An exemplary lift 10 according to embodiments of the present invention is shown in FIGS. 1-4 being used to lift an item 12. As illustrated, the lift 10 may comprise a housing 14 that at least partially encloses a lifting assembly 16 that is used to raise and lower the item 12. The item 12 illustrated in FIGS. 1-4 is shown simply as a rectangular bar. However, it should be understood that the item 12 may be illustrative of other items, and particularly heavy items, such as vehicles.

The lift 10 is illustrated in the figures as a floor-service lift with a handle 20 and wheels 22. As such, the lift 10 may be easily maneuvered for placement in raising and/or lowering the item 12. However, it should be understood that embodiments of the present invention may be directed to other types of lifts, such as bottle jacks. As is generally known, bottle jacks are hydraulic jacks configured similar to the lifting assembly 16 shown in the figures, but which are configured to be supported directly on the ground or other lifting surface. As such, bottle jacks are generally moved manually by a user picking up the bottle jacks and placing the bottle jacks where needed for use.

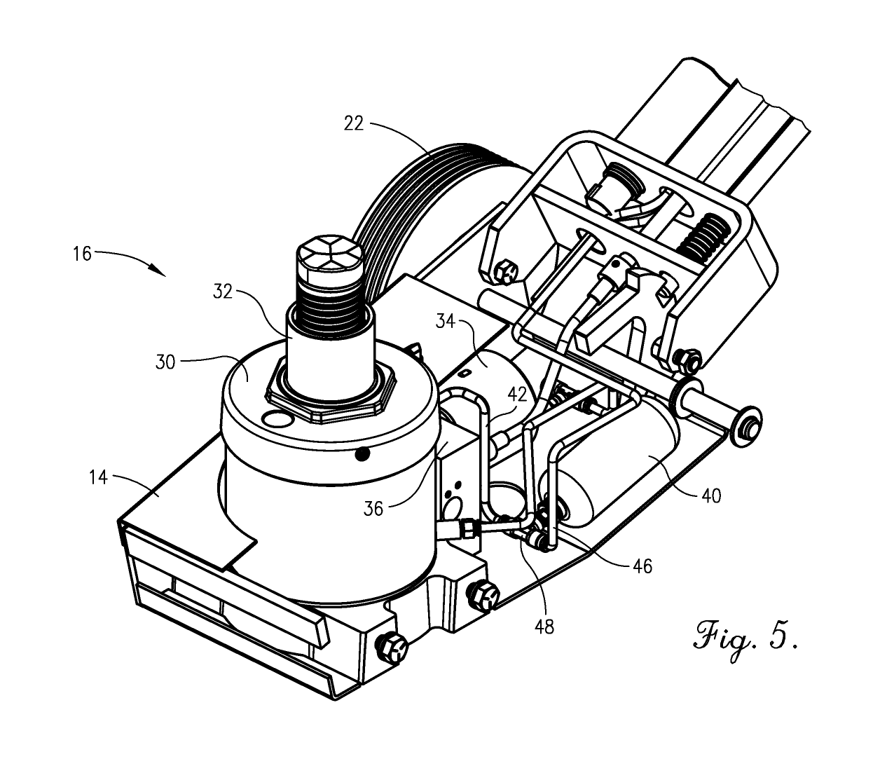

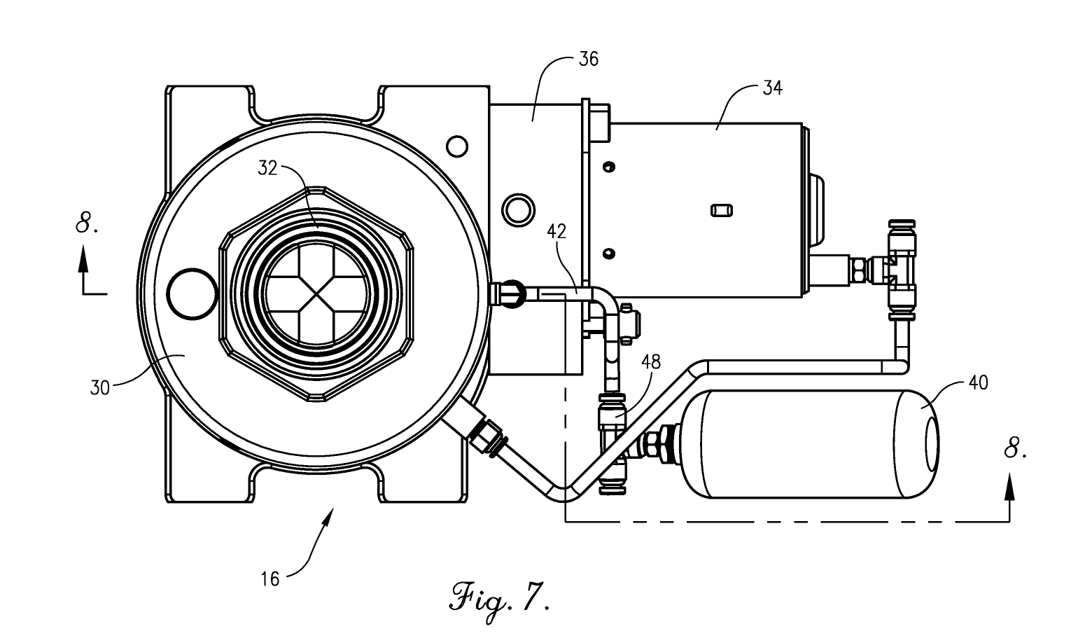

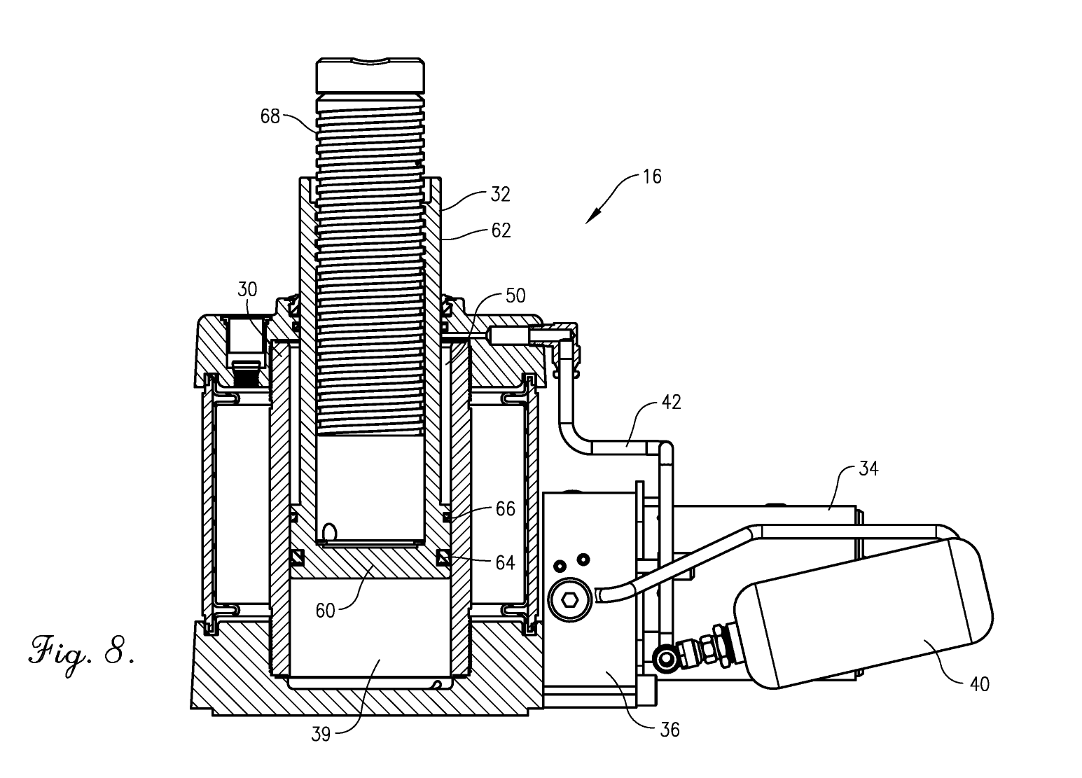

In some embodiments, the lift 10 may be a hydraulic lift. However, it should be understood that the lift 10 may be powered by other types of power sources, such as by pneumatic or electric sources. With respect to the hydraulically-powered lift 10, as illustrated in FIGS. 5-7, the lifting assembly 16 may comprise a cylinder 30, a ram 32, a hydraulic-fluid reservoir 34, and a hydraulic pump 36. As perhaps illustrated in FIG. 8, the hydraulic pump 36 can pump hydraulic fluid from the hydraulic-fluid reservoir 34 into a ram chamber 39 presented in a bottom portion of the cylinder 30 so as to force the ram 32 upward under pressure from the hydraulic fluid. As such, the ram 32 can be caused to extend from the cylinder 30, so as to raise an item, such a vehicle. To lower the ram 32 back into the cylinder 30, the hydraulic pump 36 can pump hydraulic fluid away from the ram chamber 39 within the cylinder 30 and back into the hydraulic-fluid reservoir 34, so as to permit the ram 32 to retract. Specifically, a weight of the ram 32 and/or the weight of the item being raised/lowered can cause the ram 32 to retract back within the cylinder 30 as the hydraulic fluid is removed from the ram chamber 39. In some embodiments, the hydraulic pump 36 may be electrically operated. In other embodiments, the hydraulic pump 36 may be mechanically operated, such as by actuating the handle 20 of lift 10 (e.g., pumping the handle repeatedly upward and downward). In further alternative embodiments, the hydraulic pump 36 may be pneumatically operated, such as by a pneumatic motor powered via an external air source.

In some instances, however, a certain amount of hydraulic fluid will remain within the ram chamber 39 of the cylinder 30 during lowering of the lift 10. As such, the weight of the ram 32 may not be sufficient to counteract the pressure of the remaining hydraulic fluid such that the ram 32 will not fully retract within the cylinder 30. Nevertheless, embodiments of the present invention include a ram retract system for causing the ram 32 to fully retract within the cylinder 30. As perhaps best shown in FIG. 5, the ram retract system may comprise an air-storage reservoir 40 fluidly connected to the cylinder 30 via a supply conduit 42. The air-storage reservoir 40 may comprise generally any type of container configured to hold air or other gas under pressure and that can be integrated within and/or otherwise attached to the lift 10. For instance, the air storage reservoir may comprise a metal vessel, such as a carbon dioxide (CO₂) cartridge. In other embodiments, the air storage reservoir may be formed from plastic, such as PVC or CPVC pipe material. As shown in FIG. 5, the air-storage reservoir 40 may be at least partially enclosed within the housing 14 of the lift 10. However, in other embodiments, the air-storage reservoir 40 may be secured to an exterior of the lift 10.

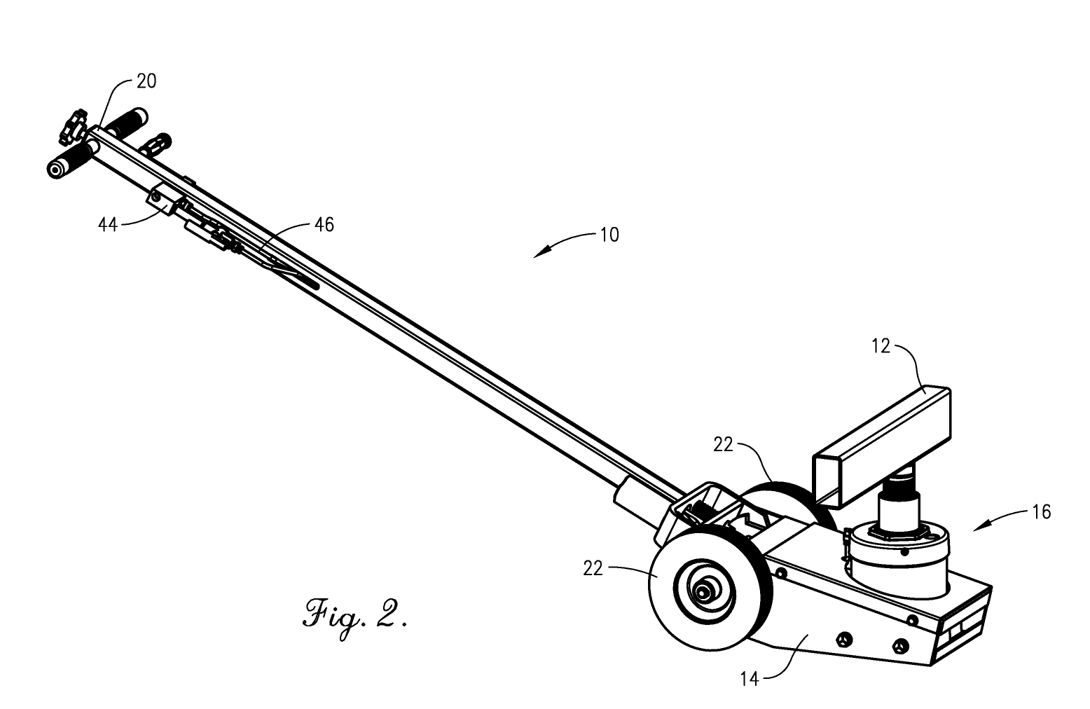

The air-storage reservoir 40 may also be fluidly connected to a pneumatic port 44 (See FIG. 2) via a supply conduit 46. As shown in FIG. 2, the pneumatic port 44 may be positioned at a distal end of the handle 20 of the lift 10, such that the supply conduit 46 extends up from the air-storage reservoir 40 along the handle 20 of the lift 10 to the pneumatic port 44. It should be understood that the supply conduits 42, 46 may comprise generally any type of pneumatic tubing capable of permitting fluid to pass therethrough. For instance, the supply conduits 42, 46 may comprise plastic or metal tubing. In some embodiments, the supply conduits 42, 46 may be sized large enough so as to function as the air-storage reservoir 40 (i.e., to hold pressurized air therein). In such embodiments, there may not be a need for an individual air-storage reservoir separate from one or more of the supply conduits 42, 46.

The pneumatic port 44 may be configured to fluidly connect to an external air-pressure source (not shown and referred to herein as an “external air source”). For instance, the external air source may be an electric or gas-powered air compressor. Regardless, with the external air source connected to the pneumatic port 44 of the ram retract system, the external air source can provide pressurized air to the air-storage reservoir 40. Once the air-storage reservoir 40 has been filled with pressurized air, such as from the external air source, the air-storage reservoir 40 is configured to retain such pressurized air for use in retracting the ram 32, as will be described in more detail below. To ensure the air-storage reservoir 40 can maintain sufficient pressurized air, the air-storage reservoir 40 may be associated with a one-way check valve. For instance, the ram retract system may include a one-way check valve within a T-junction 48 used to connect the air-storage reservoir 40 with the supply conduits 42, 46, as is shown in FIG. 5-7. Specifically, the one-way check valve may be positioned within or adjacent to a portion of the T-junction 48 that connects with the supply conduit 46. In alternative embodiments, the one-way check valve may be positioned within the supply conduit 46 or within the pneumatic port 44. Regardless, the one-way check valve can function to prevent air from flowing from the air-storage reservoir 40, back up the supply conduit 46, and out the pneumatic port 44 when the pneumatic port 44 is disconnected from the external air source.

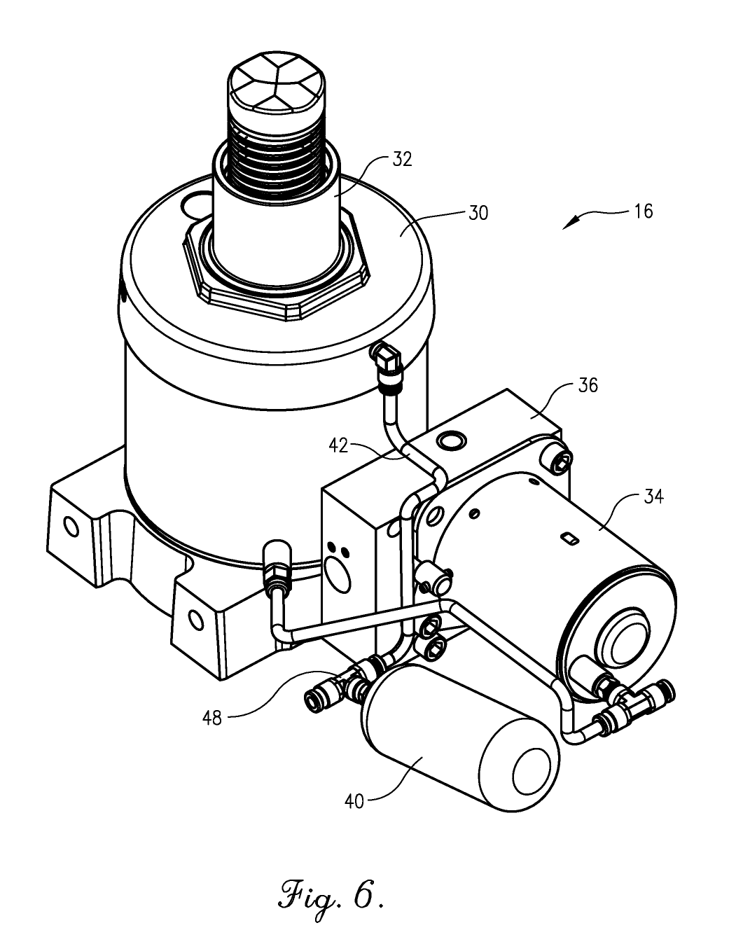

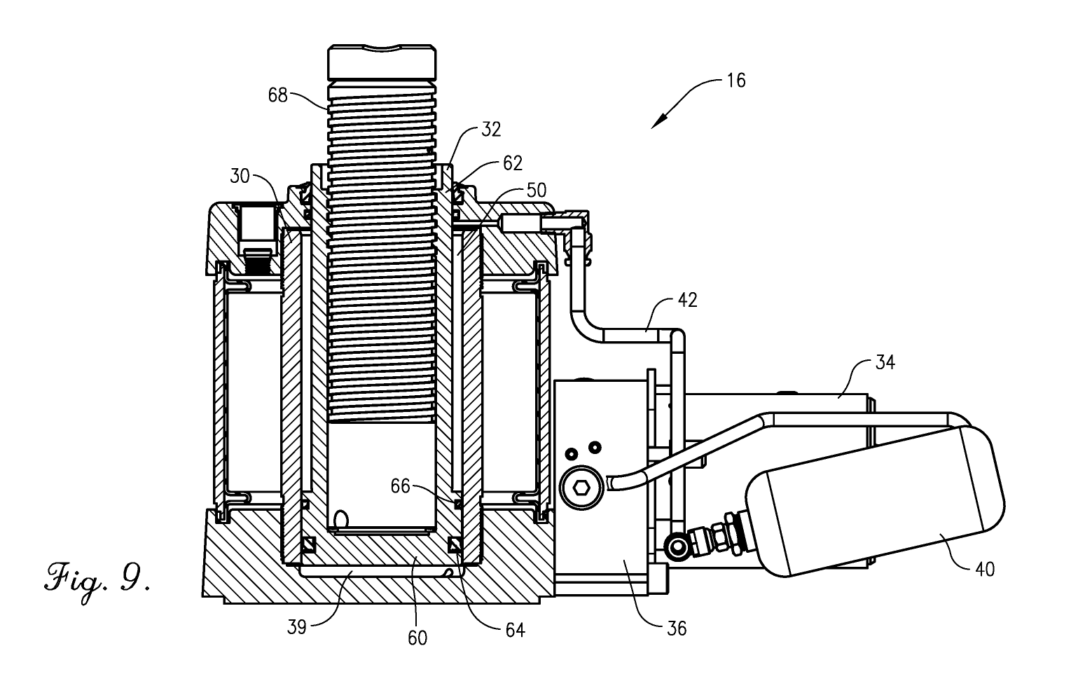

As perhaps best shown in FIGS. 6, 8, and 9, the air-storage reservoir 40 is also fluidly connected to the lifting assembly 16 via the supply conduit 42. Specifically, the supply conduit 42 extends from the T-junction 48 (the side of the T-junction opposite the supply conduit 46) to the cylinder 30. As perhaps best shown in FIGS. 8 and 9, the supply conduit 42 may be fluidly connected to an air-receiving space 50 presented between the cylinder 30 and the ram 32. Due to such fluid connection, pressurized air stored within the air-storage reservoir 40 can be injected into the air-receiving space 50 so as to force the ram 32 down to a fully retracted position within the cylinder 30.

In more detail, as shown in FIGS. 8 and 9, the ram 32 may comprise a cylindrical base section 60 and an elongated, cylindrical main section 62 extending upward from the base section 60. The base section 60 may be sized in a corresponding manner with an interior diameter of the cylinder 30, such that the base section 60 and an interior wall of the cylinder 30 sealingly engage with each other. The base section 60 may include a pair of annular seals (e.g., ring seals) that function to seal the base section 60 of the ram 32 within the cylinder 30. Specifically, a lower annular seal 64 may seal the ram 32 with respect to the ram chamber 39 presented within a lower portion of the cylinder 30 a between the bottom of the cylinder 30 and a bottom of the base section 60 of the ram 32. An upper seal 66 may seal the ram 32 with respect to the air-receiving space 50 presented within an upper portion of the cylinder 30 between sidewalls of the cylinder 30 and a top of the base section 60 of the ram 32. It should be understood that, in some embodiments, the ram 32 may include an extension screw 68 associated therewith, which permits additional extension of the ram's 32 length.

In operation, the lift 10 may be used to raise and lower a heavy item 12, such as a vehicle. Before operation, the lift 10 may be connected (at the pneumatic port 44) to an external air source, such as an electric air compressor, which supplies compressed air to the lift 10. When connected to the external air source, the external air source can fill the air-storage reservoir 40 with pressurized air. As discussed above, the air-storage reservoir 40 is configured to maintain pressurized air within the air storage reservoir 40. Specifically, as discussed in more detail below, the air-storage reservoir 40 is configured to maintain an amount of pressurized air necessary to cause the ram 32 to fully retract within the cylinder 30. In more detail, with the external air source being connected to the lift 10, the external air source will maintain pressurized air within the supply conduit 46 and in the air-storage reservoir 40. In contrast, if the external air source (which was used to fill the air-storage reservoir 40 with pressurized air) is disconnected from the lift 10, the air-storage reservoir 40 will maintain the pressurized air therein by way of the one-way check valve, which prevents the pressurized air from escaping from the air-storage reservoir 40, back up the supply conduit 46, and out the pneumatic port 44. It should be understood that the lifting assembly 16 seals that air-storage reservoir 40 at the other side of the T-junction 48, so as to prevent the pressurized air from escaping from the air-storage reservoir 40 from the supply conduit 42.

The lift 10 can be used to perform its normal function of raising and lowering an item 12, such a vehicle. For instance, the lift 10 can be used to raise the item 12, such that maintenance or repair can be performed on the item 12. To perform such a raising operation, and with reference to FIG. 8, the hydraulic pump 36 can pump hydraulic fluid from the hydraulic-fluid reservoir 34 to the ram chamber 39 between the cylinder 30 and the bottom of the base section 60 of the ram 32. As such, the ram 32 will be forced to extend upward out from the cylinder 30 so as to raise the item 12. FIG. 8 illustrates the ram 32 being extended outward from the cylinder 30 in an exemplary raised position. It should be understood that the raising of the item (e.g., the vehicle) by the lift 10 can be performed while the lift 10 is either connected or disconnected from the external air source. However, if the lift 10 is disconnected from the air source when performing raising operations, it will generally be preferable for the lift 10 to have been connected to the external air source prior to the lifting operations so that the air-storage reservoir 40 can be filled with pressurized air from the external air source.

After such maintenance or repair has been completed, the lift 10 can lower the item 12. Specifically, the hydraulic pump 36 can pump hydraulic fluid from the ram chamber 39 back into the hydraulic-fluid reservoir 34. As such, the ram 32 will retract downward (under its own weight and the weight of the item 12) back into the cylinder 30 so as to permit the item 12 to lower. Such lowering operations may be performed with the lift 10 connected or disconnected from the external air source. However, as described in more detail below, embodiments of the present invention beneficially provide for the ram 32 to be fully retracted back into the cylinder 30 after lowering the item (e.g., the vehicle) even when the lift 10 is not connected to the external air source.

Once the item 12 has been completely lowered, the ram 32 will, due to its own weight, continue to retract within the cylinder 30. However, in some instances, the weight of the ram 32 will be insufficient to cause the ram 32 to fully retract within the cylinder 30. To address such an issue, the ram retract system of the lift 10 may be used to cause the ram 32 to fully retract within the cylinder 30. Specifically, and with reference to FIG. 9, the pressurized air held within the air-storage reservoir 40 can be caused to travel through the supply conduit 42 into the air-receiving space 50 so as to apply a force onto the top of the base section 60 of the ram 32 so as to force the ram 32 to fully retract within the cylinder 30. FIG. 9 illustrates the ram 32 being retracted down within the cylinder 30 in an exemplary lowered and fully-retracted position. As noted above, such full retraction can be performed even with the lift 10 not being connected to the external air source.

In some embodiments, the air-storage reservoir 40 will be in continuous fluidic connection with the air-receiving space 50 so as to automatically provide pressurized air within the air-receiving space 50 to force the ram 32 downward, retracted within the cylinder 30. However, in other embodiments, the ram retract system may include a trigger mechanism (e.g., a manual switch, a sensor-activated switch, or the like), which can bring the air-storage reservoir 40 into fluidic connection with the air-receiving space 50 of the cylinder 30. Regardless, it is understood that the amount of pressurized air supplied from the air-storage reservoir 40 (and, thus, stored in the air-storage reservoir 40) to the air-receiving space 50 is sufficient to apply a force against the ram 32 so as to counteract any remaining forces acting against the ram 32 due to remaining hydraulic fluid within the ram chamber 39 and/or due to friction between the ram 32 and the cylinder 30.

If the air-storage reservoir 40 is still in connection with the external air source (e.g., via the pneumatic port 44 and the supply conduit 46) after the ram 32 has been caused to be fully retracted within the cylinder 30, the air-storage reservoir 40 may be simultaneously re-filled with pressurized air from the external air source, thus, maintaining the amount of pressurized air within the air storage reservoir that is necessary to again fully retract the ram 32 within the cylinder 30. In certain alternative embodiments, when the external air source is maintained in connection with the lift 10 (e.g., during raising and lowering operations), pressurized air from the external air source may be directly provided to the air-receiving space 50, via the supply conduits 42, 46, such that pressurized air does not leave the air-storage reservoir 40 and the air-storage reservoir 40 does not need to be refilled.

In contrast, if during operation of the lift 10, the lift 10 is disconnected from the external air source (e.g., during raising and/or lowering operations), the pressurized air stored within the air-storage reservoir 40 will be transmitted through the supply conduit 42 to the air-receiving space 50 so as to force the ram 32 to fully retract down within the cylinder 30. As was noted previously, the amount of pressurized air stored within the air-storage reservoir 40 should be sufficient to completely retract the ram 32 down within the cylinder 30 even if the lift 10 is no longer connected to the external air source. However, in such instances, the air-storage reservoir 40 may not be re-filled until the lift 10 is once again connected to the external air source. In some embodiments, however, the air-storage reservoir 40 may be large enough that it can retain enough pressurized air to retract the ram 32 multiple times (e.g., after multiple raise and lower operations) without needing to be re-filled.

In view of the above, embodiments of the present invention are configured to cause the ram 32 of the lift 10 to be fully retracted within the cylinder 30 (e.g., as shown in FIG. 9) after the ram 32 has been extended to lift an item (e.g., as shown in FIG. 8). Such retraction can be performed even when the lift 10 is not connected to an external air source. Beneficially, such retraction minimizes the possibility of damage to the lift 10 and/or to the item 12 being raised/lowered by the 10. In addition, the ability to fully retract the ram 32 within the cylinder 30 adds to the longevity and service life of the lift 10 by leaving the ram 32 unexposed to damage resulting from handling, misuse, and/or weathering.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A lift for raising and lowering items, wherein said lift comprises:
a lifting assembly including—
a cylinder, and
a ram configured to extend from and retract within said cylinder; and
an air-storage reservoir configured to store pressurized air received from an external air source,
wherein said air-storage reservoir is fluidly connected to said lifting assembly, wherein said air-storage reservoir is configured to cause said ram to retract within said cylinder even when said lift is not connected to the external air source.

2. The lift of claim 1, wherein said air-storage reservoir comprises a rigid container.

3. The lift of claim 1, wherein said lift comprise a housing, and wherein said air-storage reservoir is at least partially enclosed within said housing.

4. The lift of claim 1, wherein said lift further comprises a hydraulic system for providing a hydraulic force to said lifting assembly for actuating said ram.

5. The lift of claim 4, wherein said air-storage reservoir is configured to provide pressurized air to said lifting assembly, wherein said pressurized air is sufficient to overcome the hydraulic force so as to cause said ram to retract within said cylinder.

6. The lift of claim 5, wherein said pressurized air is sufficient to cause said ram to fully retract within said cylinder.

7. The lift of claim 5, wherein said lifting assembly presents an air-receiving space between said cylinder and said ram for receiving pressurized air from said air-storage reservoir.

8. The lift of claim 7, wherein said air-storage reservoir is fluidly connected to said air-receiving space in said lifting assembly via pneumatic tubing.

9. The lift of claim 1, wherein said lift includes a pneumatic port, and wherein said air-storage reservoir is configured to be fluidly connected to the external air source via said pneumatic port.

10. The lift of claim 1, wherein said lift is a floor-service lift comprising one or more wheels and handle for maneuvering said lift.

11. The lift of claim 1, wherein said air-storage reservoir is associated with a one-way check valve for preventing pressurized air from exiting said air-storage reservoir.

12. A lift for raising and lowering vehicles, wherein said lift comprises:
a lifting assembly including—
a cylinder, and
a ram configured to extend from and retract within said cylinder,
wherein a space is presented between said cylinder and said ram; and
an air-storage reservoir fluidly connected to said space between said cylinder and said ram and configured to generate a pneumatic force against said ram so as to retract said ram within said cylinder, wherein said air-storage reservoir is configured to generate the pneumatic force without being connected to an external air source.

13. The lift of claim 12, wherein said lift comprise a housing, and wherein said air-storage reservoir is at least partially enclosed within said housing.

14. The lift of claim 12, wherein said lift further comprises a hydraulic system for providing a hydraulic force to said lifting assembly for actuating said ram, wherein said air-storage reservoir is configured to provide pressurized air into the space between said cylinder and said ram so as to create the pneumatic force against said ram, and wherein said pneumatic force is sufficient to overcome the hydraulic force so as to cause said ram to retract within said cylinder.

15. A method of operating a lift, with the lift including a cylinder, a ram, and an air-storage reservoir, wherein said method comprises the steps of:
(a) connecting the lift to an external air source;
(b) raising the vehicle with the lift;
(c) disconnecting the external air source from the lift;
(d) lowering the vehicle with the lift; and
(e) after said disconnecting and lowering of steps (c) and (d) causing, via compressed air stored within the air-storage reservoir, the ram to retract within the cylinder.

16. The method of claim 15, wherein prior to said disconnecting of step (c), the air-storage reservoir is filled with pressurized air from the external air source.

17. The method of claim 16, wherein said causing of step (e) is performed by supplying the pressurized air from the air-storage reservoir against the ram.

18. The method of claim 15, wherein during said lowering of step (d), the ram of the lift is at least partially retracted within the cylinder.

19. The method of claim 15, wherein during said causing of step (e), the ram of the lift is fully retracted within the cylinder

20. The method of claim 15, wherein said disconnecting of step (c) is performed prior to said lifting of said step (b).
